(19) United States
(12) Patent Application Publication
(10) Pub. No.: US 2010/0224707 A1
(43) Pub. Date: Sep. 9, 2010

(54) DEVICE FOR SUBJECTING AN OBJECT TO THE ACTOIN OF A FLUID

(75) Inventors: Markus Rathey, Bad Bellingen (DE); Daniel Utz, Bad Bellingen (DE)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/063,062

(22) PCT Filed: Jul. 13, 2006
(86) PCT No.: PCT/EP06/06839

§ 371 Date: Feb. 6, 2008

(30) Foreign Application Priority Data
Aug. 18, 2005 (DE) 10 2005 039 009.9

(51) Int. Cl. B05B 1/00

(52) U.S. Cl. 239/589

(57) ABSTRACT

The invention relates to a device for subjecting an object to the action of a liquid, for example, a window pane of a motor vehicle with a cleaning liquid, with a retaining body (1), which can be connected to a liquid line arrangement, and with a nozzle body (12). The nozzle body (12) is provided with a cylindrical design and can be inserted into a location space (8) of the retaining body (1) whereby being rotationally mounted therein. Rotating the nozzle body (12) about the cylinder axis permits a liquid jet or liquid fan to be adjusted with regard to its outlet angle, this liquid jet or fan exiting via an outlet end (18), which is formed in the nozzle body (12), and via an outlet recess (7) formed inside the retaining body (1). A long serviceable life is achieved due to this cylindrical design.

### BACKGROUND OF THE INVENTION

1. Field of the Invention

The invention relates to a device for subjecting an object to the action of a fluid.

2. Description of the Related Art

One device for subjecting an object to the action of a fluid is known from EP 1 564 095 A2. The prior device for subjecting an object to the action of a fluid comprises a holding body, which is connectable to a fluid line arrangement, and a nozzle body. The nozzle body is rotatably mounted on the holding body and stands connected fluid-mechanically to the holding body. The nozzle body has a cylindrical shape, with a beveled, flat first end face, a second end face disposed opposite the first end face and configured with adjusting means, and a nozzle conduit arrangement having an outlet end. The holding body is provided with a smooth-walled, cylindrical receiving space which is configured with an outlet opening and into which the nozzle body is inserted.

Known from WO 2005/021341 A1 is a device very similar to that of the aforesaid document, but in which the nozzle body presents a sharp-edged transition from the first end face to a middle part.

Known from FR 2 803 542 A1 and WO 2004/056627 A1 are devices for subjecting an object to the action of a fluid that comprise a nozzle body which is rotatably mounted in a holding body and is configured similarly to the aforesaid devices with respect to fluid mechanics. In this device, the nozzle body is configured with a stepped middle part, the first end face being configured with a projection that engages in a circumferentially larger recess formed in the holding body, thus forming a stop limit for the rotation of the nozzle body.

In all the prior devices, a slot-like recess, as an adjusting means, is formed on the second end face so that the nozzle body can be rotated relative to the holding body.

Known from DE 102 25 087 A1 is a spray gun with a knob having a grip-like elevation, for adjusting the direction of an exiting spray jet.

Known from FR 2 035 061 A is a device for subjecting an object to the action of a fluid in which a cylindrical nozzle body made of metal is pressed into a plastically deformable holding insert, which is inserted in turn into a holding body. The nozzle body is rotatably mounted in the holding insert.

Known from GB 2 121 318 A is a device comprising a holding body that is connectable to a fluid line arrangement. Also present is a nozzle body, which is rotatably mounted in the holding body via a ball and socket joint and stands connected fluid-mechanically to the holding body. The universal rotatability makes it possible to adjust the direction of action of the nozzle body within set limits.

### SUMMARY OF THE INVENTION

The present invention provides a device for subjecting an object to the action of a fluid in which the nozzle body can be inserted very easily into the holding body and is held there securely even under harsh environmental conditions.

By virtue of the fact that in the device according to the invention, a mutually engaged snap collar and snap groove arrangement is configured on the bearing body and on the nozzle body between the outlet end and the second end face, the nozzle body can be inserted a relatively long way into the holding body in a substantially force-free manner, in which process a given increased resistance does not occur until the end of travel, as soon as the snap collar enters the receiving space. After the snap collar is snapped into the snap groove, the nozzle body is freely rotatable and is secured against axial displacement opposite to the direction of insertion, thereby ensuring that the outlet end cannot slide out of the region of the outlet opening.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective representation of an exemplary embodiment of a device according to the invention, comprising a holding body and a nozzle body before its insertion in the holding body;

FIG. 2 is a perspective representation of the exemplary embodiment according to FIG. 1 with the nozzle body inserted in the holding body;

FIG. 3 shows the exemplary embodiment according to FIG. 2 in cross section;

FIG. 4 shows the exemplary embodiment according to FIG. 2 in a partially cut-away perspective representation;

FIG. 5 is a perspective representation of a further exemplary embodiment of a device according to the invention comprising a nozzle body received by a snap-fit structure;

FIG. 6 shows the exemplary embodiment according to FIG. 5 in cross section; and

FIG. 7 shows the exemplary embodiment according to FIG. 5 in a longitudinal section through the nozzle body.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

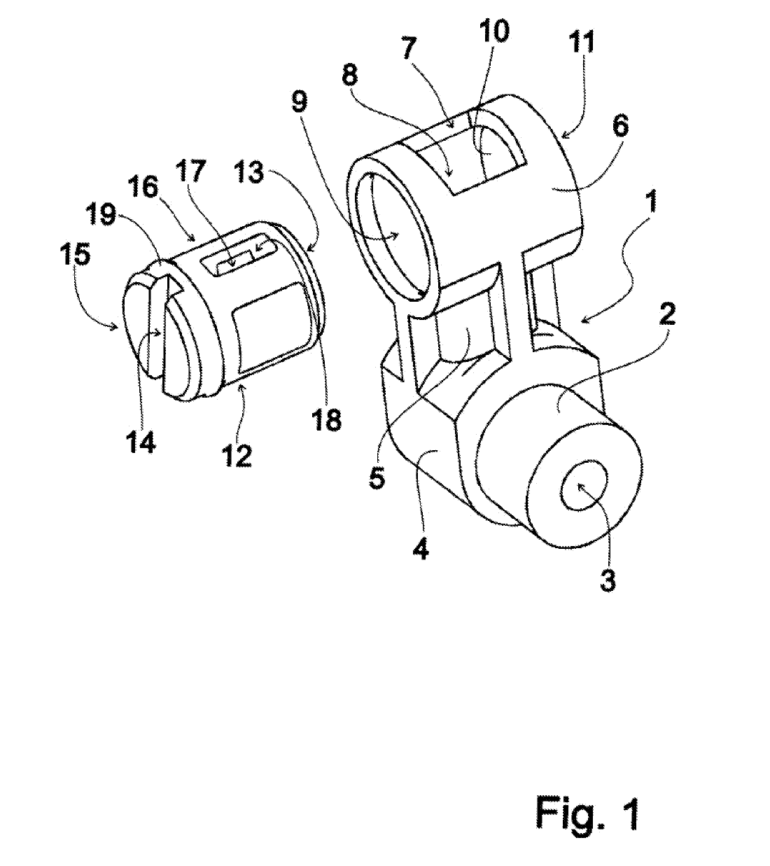

FIG. 1 is a perspective view of an exemplary embodiment of a device according to the invention for subjecting an object to the action of a fluid, for example a window pane of a motor vehicle to the action of a cleaning fluid, such as water provided with additives. This inventive device comprises a holding body 1 made of a synthetic material, which is connectable via a connecting branch 2 to a fluid line arrangement not shown in FIG. 1. The holding body 1 is configured with a feed conduit arrangement 3, by means of which the fluid can be conveyed from the fluid line arrangement through the holding body 1. The connecting branch 2 is attached to a block-like middle piece 4, which is connected in turn, via an intermediate portion 5 that is beveled for strengthening purposes, to a bearing piece 6 configured as a hollow cylinder.

Bearing piece 6 surrounds a substantially cylindrical receiving space 8 by means of an outer wall that is closed except for an outlet opening 7. Bearing piece 6 has one open end face 9 and one end face 11 that is closed by a terminating wall 10.

The exemplary embodiment of the invention depicted in FIG. 1 further comprises a nozzle body 12, which has a substantially cylindrical shape adapted to the dimensions of the receiving space 8. The nozzle body 12 has a beveled, flat first end face 13, a second end face 15, disposed opposite first end face 13 and configured with a recess arrangement 14 as adjusting means, and a middle part 16 disposed between said end faces 13, 15. In this exemplary embodiment, the recess arrangement 14 is configured as a slot adapted to engage with a flat-blade screwdriver as an adjusting tool.

In a modification not shown, the recess arrangement 14 is configured with two slots oriented at right angles to each other and adapted to engage with a cross-head screwdriver as adjusting means.

Middle part 16 receives a nozzle conduit arrangement 17, which when nozzle body 12 is arranged as intended in holding body 1 is in fluid-mechanical connection with feed conduit arrangement 3, the intended arrangement being such that an outlet end 18 of nozzle conduit arrangement 17 is disposed at least partially inside the outlet opening 7 of bearing piece 6.

Finally, it can be understood from FIG. 1 that between outlet end 18 and second end face 15 there is a circumferential, elevated snap collar 19, which protrudes slightly beyond the periphery of middle part 16.

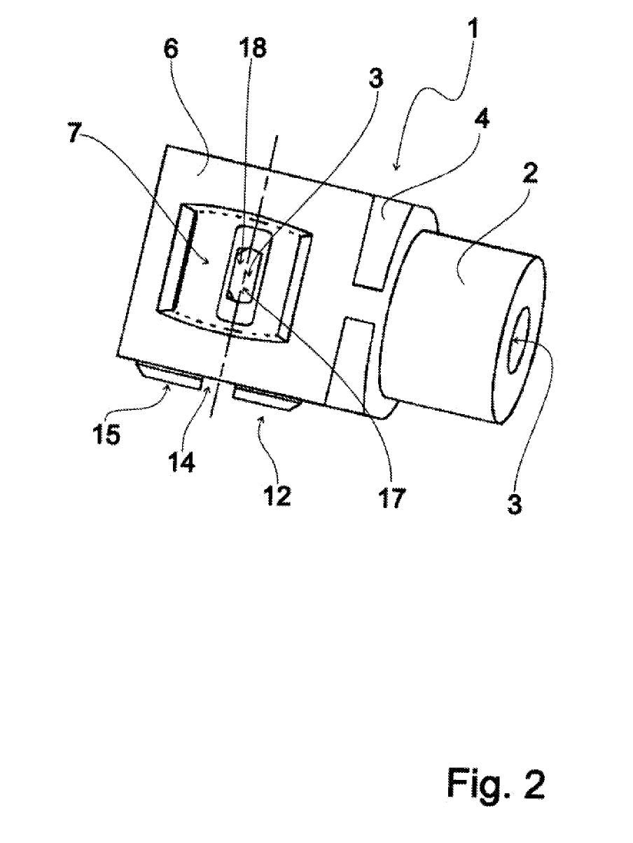

FIG. 2 is a perspective view of the exemplary embodiment according to FIG. 1 with the nozzle body 12 arranged as intended in the bearing piece 6 of holding body 1, looking toward the outlet opening. It can be seen from FIG. 2 that outlet opening 7 extends circumferentially through a given angular segment that is adequately dimensioned so that nozzle body 12, and thus outlet end 18, can be oriented to bring about the intended orientation of a fluid jet or fluid fan exiting the inventive device. It can further be understood from FIG. 2 that nozzle conduit arrangement 17 creates a fluid connection to feed conduit arrangement 3, since it stands connected fluid-mechanically to the region of feed conduit arrangement 3 surrounded by intermediate portion 5.

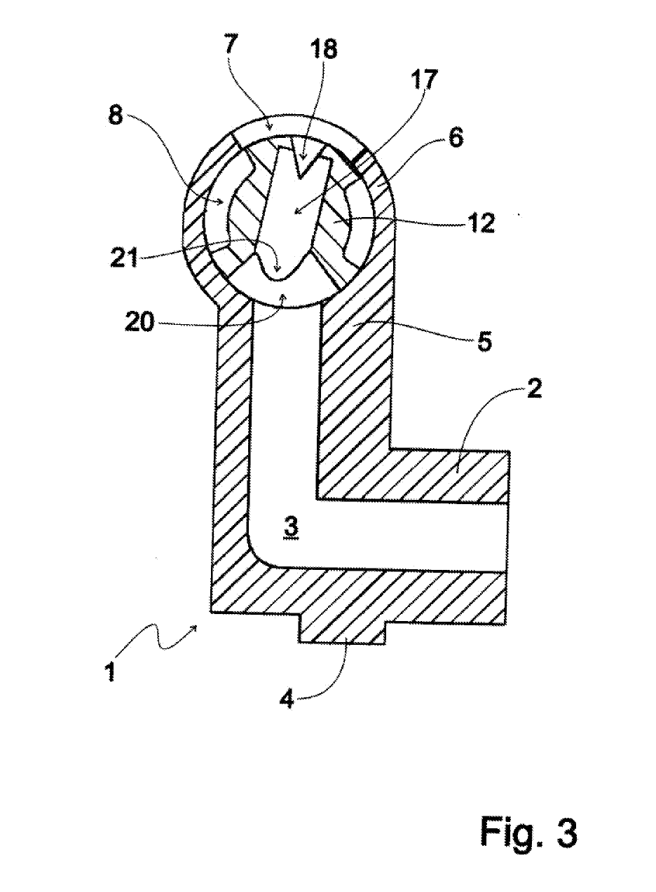

FIG. 3 shows a cross section through the previously described exemplary embodiment in the arrangement according to FIG. 2. It can be understood from FIG. 3, for one thing, that the nozzle conduit arrangement 17 is configured as a straight conduit that comprises a chamber and crosses nozzle body 12 centrally. It can further be appreciated from FIG. 3 that nozzle body 12 is configured with an inlet recess 20 on the opposite side from outlet end 18. Opening into this inlet recess 20 are, on the one hand, nozzle arrangement 17, in an inlet end 21, and, on the other hand, the end of feed conduit arrangement 3 pointing away from connecting branch 2. Inlet recess 20 here extends through an angular range that is substantially the same as the angular range of outlet opening 7, such as to ensure the fluid-mechanical connection between feed conduit arrangement 3 and nozzle conduit arrangement 17 when outlet end 18 is arranged in outlet opening 7.

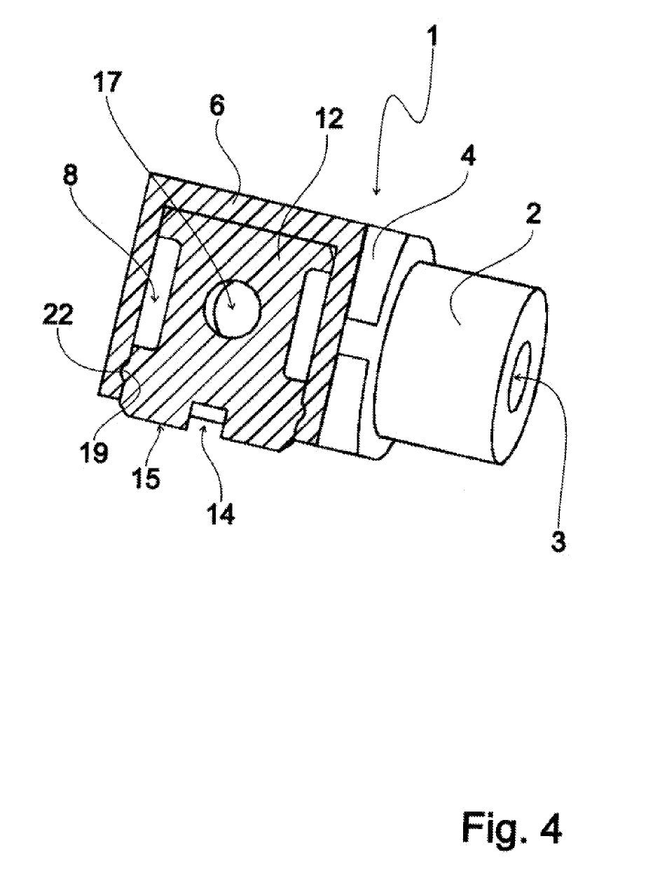

FIG. 4 shows a longitudinal section of the described exemplary embodiment in the arrangement according to FIG. 2. It is apparent from FIG. 4 that snap collar 19 engages in an also circumferential snap groove 22 formed in bearing piece 6. This secures nozzle body 12 against inadvertently coming out of bearing piece 6.

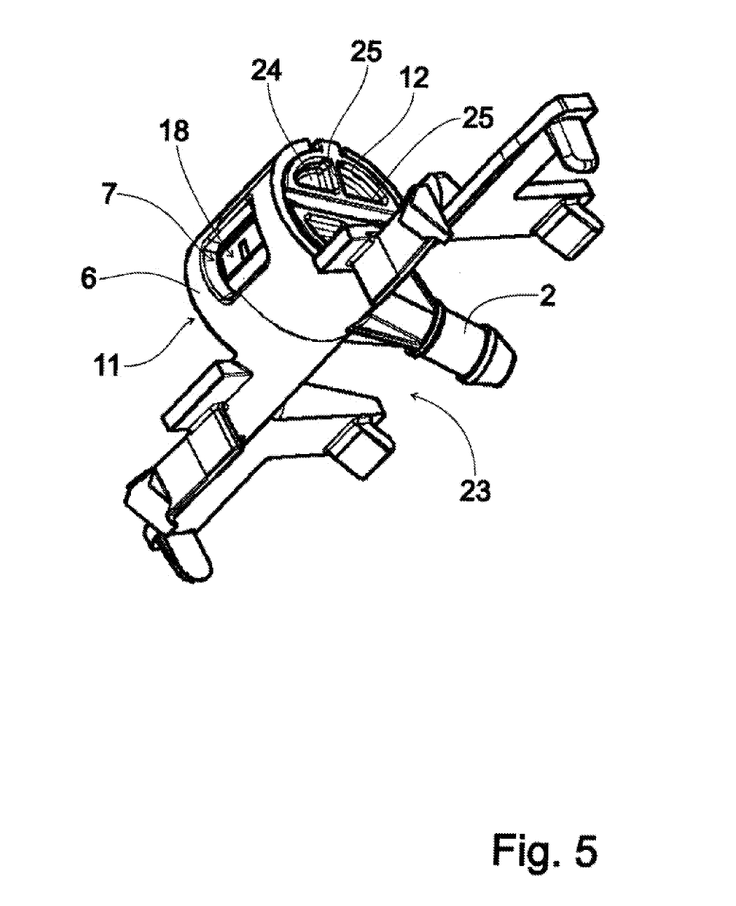

FIG. 5 shows a perspective view of a further exemplary embodiment of a device according to the invention; elements that are similar in the exemplary embodiment described with reference to FIGS. 1 to 4 and the additional exemplary embodiment described below are provided with the same reference numerals and are not described in further detail except where necessary. In the exemplary embodiment according to FIG. 5, the bearing piece 6 is connected to a snap-fit structure 23 comprising a number of snap tabs and webs, to attach the nozzle body 12 to a support element not illustrated in FIG. 5 and hold it in the intended arrangement. It can further be understood from FIG. 5 that in this exemplary embodiment the adjusting means are formed by a number of web-like elevations 25 that jut out from a base region 24 and make it possible to rotate the nozzle body 12 by hand, as well.

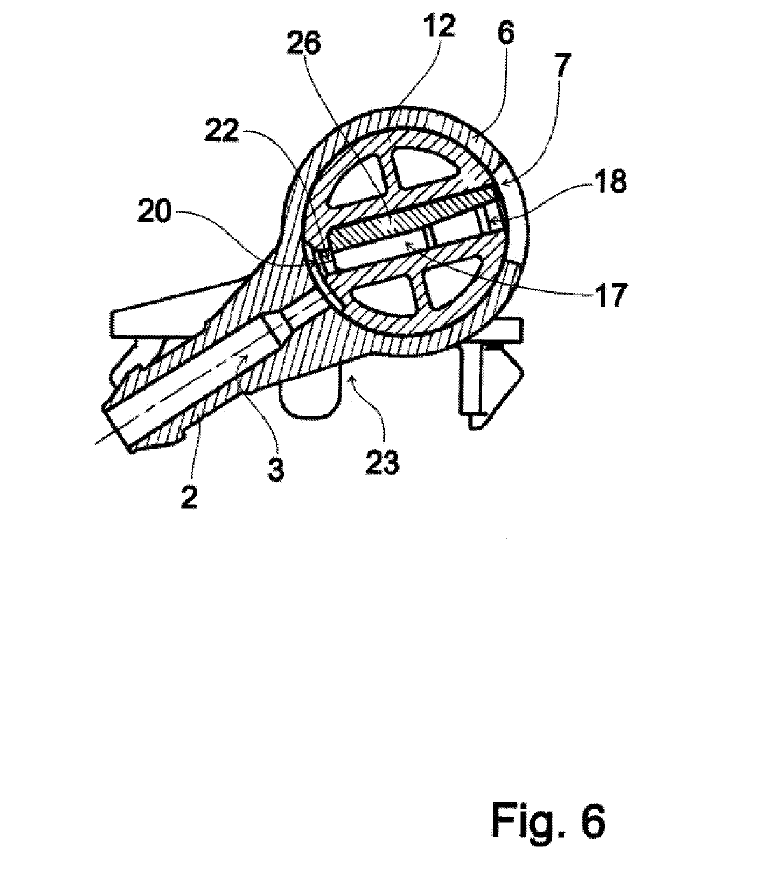

FIG. 6 shows the exemplary embodiment according to FIG. 5 in cross section. It is apparent from FIG. 6 that inserted into nozzle body 12 is a nozzle insert 26, which is preferably configured as a fan jet chip to produce an automatically oscillating output jet.

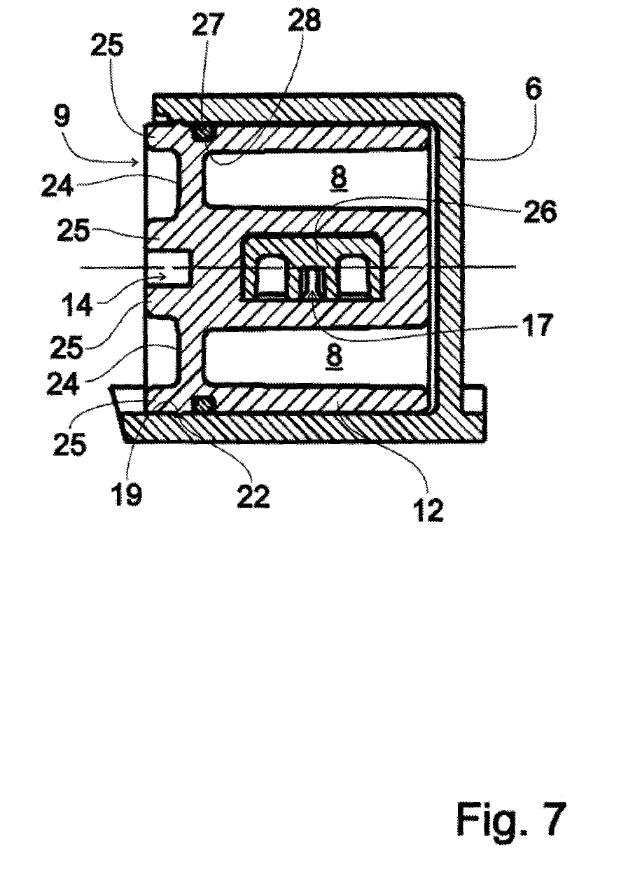

FIG. 7 shows the exemplary embodiment according to FIG. 5 in longitudinal section through the nozzle body 12. In the representation of FIG. 7, it can be seen that a circumferential sealing ring 27 is present as a seal between bearing piece 6 and nozzle body 12, and in this exemplary embodiment is disposed in receiving groove 28 formed in nozzle body 12.

Finally, it can be understood from FIG. 7 that a slot, as recess arrangement 14, is also formed in an elevation 25 formed centrally on nozzle body 12, so that nozzle body 12 can also be adjusted by means of a blade-type screwdriver.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. A device for subjecting an object to the action of a fluid, comprising:
a holding body connectable to a fluid source, said holding body including a cylindrical receiving space and an outlet opening;
a nozzle body rotatably mounted within said receiving space and in fluid communication with said holding body, said nozzle body having a cylindrical shape with a first end face, a second end face disposed opposite said first end face and including adjusting means, and a nozzle conduit having an outlet end alignable with said outlet opening of said holding body;
a snap groove provided in one of said holding body and said nozzle body; and
a snap collar provided on the other of said holding body and said nozzle body, said snap collar engaging said snap groove.

8. The device of claim 7, wherein said first end face of said nozzle body is flat and beveled.

9. The device of claim 7, wherein said snap collar is provided on said nozzle body between an outlet end and said second end face of said nozzle body.

10. The device of claim 7, wherein said holding body includes a bearing body including said receiving space, said receiving space formed in said bearing body and including said outlet opening, an open end face, and a closed end face.

11. The device of claim 10, further comprising a circumferentially extending sealing ring disposed between said bearing body and said nozzle body proximate said open end face.

12. The device of claim 7, wherein said adjusting means comprise a recess configured to mate with an adjusting tool.

13. The device of claim 12, wherein said recess is configured for the insertion of a screwdriver.

14. The device of claim 7, wherein said adjusting means includes a plurality of elevations.
